(19) United States
(12) Patent Application Publication
(10) Pub. No.: US 2007/0184786 A1
(43) Pub. Date: Aug. 9, 2007

(54) Portable communication terminal for games with foldable keypad

(75) Inventor: Young S. Kim, Los Altos, CA (US)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,889

(22) Filed: Jan. 10, 2007

Related U.S. Application Data
(60) Provisional application No. 60/758,064, filed on Jan. 10, 2006.

(30) Foreign Application Priority Data
Aug. 8, 2006 (KR) 2006-74776

(51) Int. Cl. H04B 1/38; H04M 1/00

(52) U.S. Cl. 455/90.3; 455/575.3

(57) ABSTRACT

Provided is a portable communication terminal for games with a foldable keypad. The portable communication terminal includes a main body, a foldable keypad, and a hinge unit. The main body includes a display unit, a first keypad, and a first speaker device that are exposed at all times on its top. The foldable keypad includes a second keypad and a second speaker device on its top and a third keypad on its bottom. The first keypad and the second keypad, the first speaker device and the second speaker device, are disposed in opposite sides with respect to the display unit when the foldable keypad is folded to the main body. The third keypad and the first keypad are disposed in opposite sides when the foldable keypad is unfolded from the main body. The hinge unit rotatably connects the foldable keypad to the main body.

### PRIORITY

This application claims priority under 35 U.S.C. § 119 to a provisional patent application filed in the United States Patent and Trademark Office on Jan. 10, 2006 and assigned Ser. No. 60/758,064, and under 35 U.S.C. § 119 to a patent application filed in the Korean Intellectual Property Office on Aug. 8, 2006 and assigned Serial No. 2006-74776, the contents of which are incorporated herein by reference.

### BACKGROUND OF THE INVENTION

1. Field of the Invention

The present invention generally relates to, and in particular, to a portable communication terminal such as a Digital Multimedia Broadcasting (DMB) phone, a game phone, a chatting phone, a camera phone, a Moving Picture Experts Group (MPEG) Layer-3 (MP3) phone, a cellular phone, a Personal Communication Service (PCS) phone, a Personal Digital Assistant (PDA), and a Hand Held Phone (HHP), and in particular, to a portable communication terminal for games, that is easy to use in a game mode as well as a phone mode.

2. Description of the Related Art

A portable communication terminal generally refers to an electronic apparatus which a user can carry with him/her to perform wireless communication with a desired partner. The wireless communication may be voice communication, message transmission, file transmission, video communication, and a camera function. Additionally, the portable communication terminal serves as a personal agent by performing phone number management and personal schedule management.

To enhance portability, designs of the portable communication terminal tend to be compact, slim, and light. In addition, the designs include multimedia availability for a wide variety of service functions, e.g., entertainment functions including game services. In particular, future portable communication terminals are expected to incorporate greater multi-functionality and multi-purpose utilization including video communication, game, Internet, and camera functions as well as a voice communication function.

Conventional portable communication terminals may be classified into various types according to their appearance in consideration of portability and convenience in use, such as bar-type portable communication terminals and folder-type portable communication terminals. The bar-type portable communication terminal has a single housing shaped like a bar in which data input/output devices, an antenna device, and transmission/reception devices are mounted. The folder-type portable communication terminal has a folder coupled to a single bar-shaped housing by a hinge device in such a manner that the folder can be rotated in order to be folded towards and unfolded away from the housing. A folder is rotatably coupled to a main body by a hinge unit, keys are disposed in the main body, and a display unit is disposed in the folder in the folder-type portable communication terminal, contributing to miniaturization and portability. An example folder-type portable communication terminal is disclosed in U.S. Pat. No. 6,865,406. In the disclosed folder-type portable communication terminal, a camera lens housing is mounted in a hinge unit.

Additionally, the portable communication terminals may be further classified as swing-type communication terminals and sliding-type communication terminals based upon the manner of opening and closing the communication terminals. In the swing-type portable communication terminals, two housings are coupled to each other to allow one housing to rotate open or closed relative to the other while facing each other. In the sliding-type portable communication terminal, two housings are coupled to each other to allow one housing to slide along a longitudinal direction to open or close the sliding-type portable communication terminal.

For example, in the sliding-type portable communication terminal, a main body and a slider are coupled to each other by a sliding module while facing each other, a plurality of keys are disposed in the main body, and a display unit is disposed in the slider. Such a structure is advantageous to a wide display unit and provides easiness in opening/closing operations. An example sliding-type portable communication terminal is disclosed in detail in U.S. Pat. No. 6,822,871. In the sliding-type portable communication terminal, a plurality of keys are disposed in a main body housing and a display unit is mounted in a sliding housing.

Further detail regarding the swing-type portable communication terminal is provided in U.S. patent application Ser. No. 10/822,380.

In conventional folder-type portable communication terminals, a user is not highly inconvenienced in a data input, and a displayed data check operation can be provided in a phone mode or text message transmission mode. However, in multimedia environments, the promptness or accuracy of a data input operation such as key pressing is necessary in a game mode and a wide screen cannot be provided in a display unit. The promptness and accuracy of key manipulation are more important in the game mode than in any other modes. In particular, key manipulation using both hands instead of one hand is crucial for improving promptness and accuracy.

Of course, attempts to solve the foregoing problems by increasing the size of the portable communication terminal, mounting a wide display unit in the portable communication terminal, and including more keys in the portable communication terminal are contrary to the miniaturization trend and will cause user inconvenience by reducing portability.

A portable communication terminal that provides easier use in a game mode as well as a phone mode is disclosed in U.S. patent application Ser. No. 10/946,838. However, the portable communication terminal disclosed in the U.S. patent application Ser. No. 10/946,838 has a complex mechanical internal structure, causing a difficulty in assembly, and lower reliability.

Therefore, there is a need for a portable communication terminal that can be used as a folding type in a phone mode in consideration of miniaturization and portability and can provide easiness in key manipulation with both hands in the game mode. Furthermore, a wide display device and a sound system for providing a real-like game in the game mode are required.

### SUMMARY OF THE INVENTION

It is, therefore, an object of the present invention to provide a portable communication terminal that is easy to use in a game mode as well as in a phone mode.

It is another object of the present invention to provide a portable communication terminal having easy to manipulate keys using both hands while in a game mode, providing a wide display unit, and playing stereo sounds through two speaker devices in a folder-type portable terminal, thereby allowing a user to enjoy a more real-like game in the game mode.

It is further another object of the present invention to provide a portable communication terminal, in which a table standing protrusion is included in the bottom of a main body to protect a camera lens from direct impact to a table or the ground.

It is further another object of the present invention to provide a portable communication terminal, in which a foldable keypad that is a double-sided keypad is rotatably included in a main body and is easily folded or unfolded according to mode switching.

To achieve the above and other objects, there is provided a portable communication terminal including a main body, a foldable keypad, and a hinge unit. The main body includes a display unit, a first keypad, and a first speaker device that are exposed at all times on its top. The foldable keypad includes a second keypad and a second speaker device on its outer side and a third keypad on its inner side. The first keypad and the second keypad are disposed in opposite sides with respect to the display unit and the first speaker device and the second speaker device are disposed in opposite sides with respect to the display unit when the foldable keypad is folded to the main body. The third keypad and the first keypad are disposed in opposite sides when the foldable keypad is unfolded from the main body. The hinge unit rotatably connects the foldable keypad to the main body.

### BRIEF DESCRIPTION OF THE DRAWINGS

The above and other objects, features and advantages of the present invention will become more apparent from the following detailed description when taken in conjunction with the accompanying drawings in which:

FIG. 1 is a front perspective view of a portable communication terminal for games according to the present invention in which a foldable keypad is closed;

FIG. 2 is a rear perspective view of a portable communication terminal for games according to the present invention in which the foldable keypad is closed;

FIG. 3 is a view of a portable communication terminal for games according to the present invention in which the foldable keypad is completely opened; and

FIG. 4 is a perspective view of the portable communication terminal of FIG. 3 viewed from the bottom.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for conciseness.

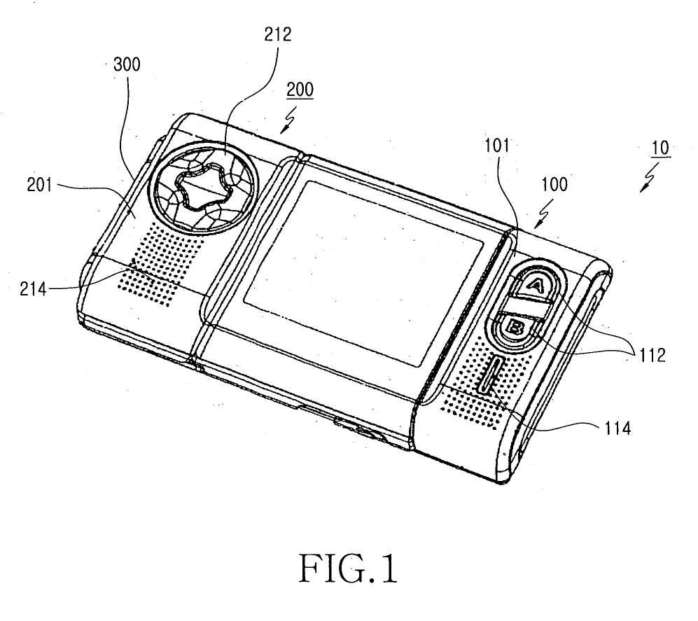

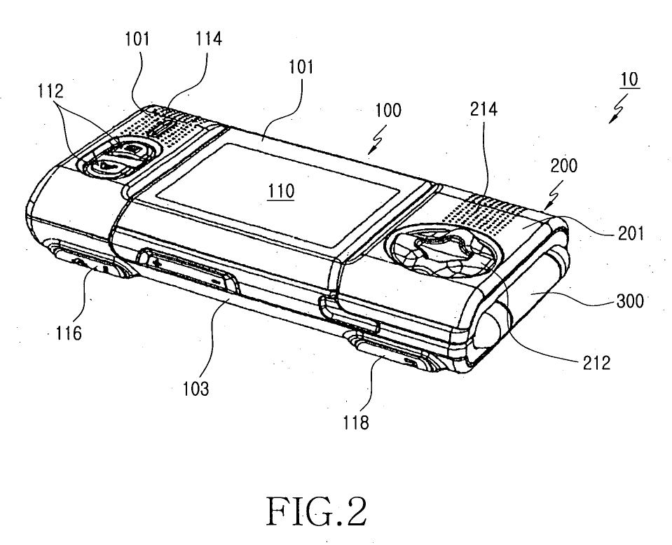

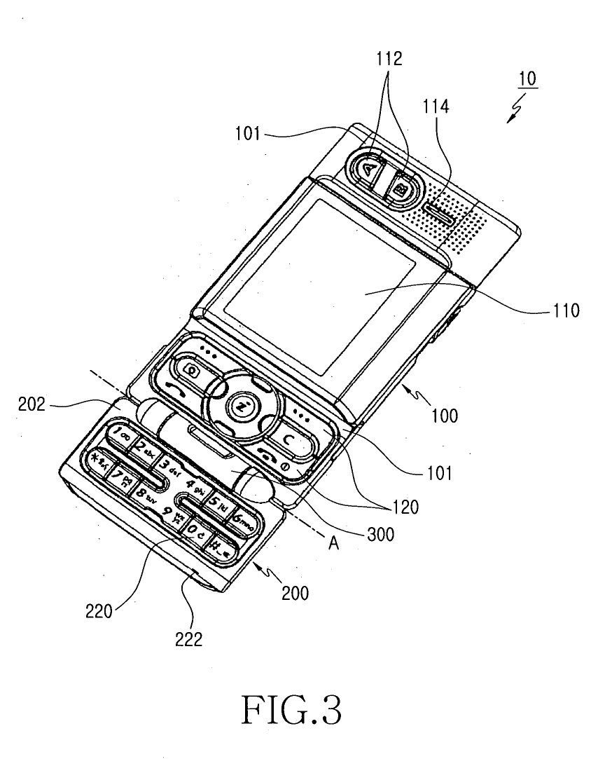

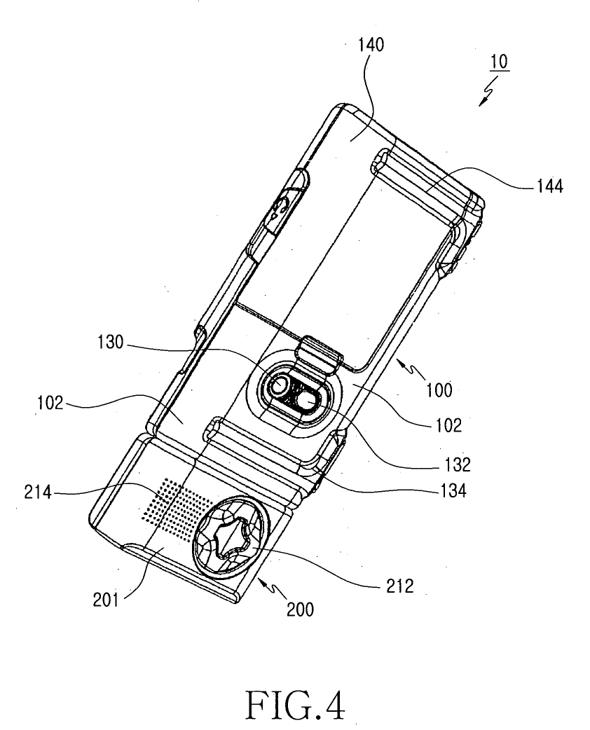

As shown in FIGS. 1 through 4, a portable communication terminal 10 according to the present invention includes a foldable keypad 200, that is easy to use in a game mode as well as a phone mode. The portable communication terminal 10 includes a main body 100, the foldable keypad 200, and a hinge unit 300. The hinge unit 300 rotatably couples the foldable keypad 200 to the main body 100. The main body 100 takes the form of a bar extending in a longitudinal direction. The foldable keypad 200 extends perpendicularly to the longitudinal direction of the main body 100 to open and close a lower portion (in which a fourth keypad 120 shown in FIG. 3 is disposed) of the main body 100. The foldable keypad 200 is disposed in the shape of a bar by being folded to the main body 100 in FIGS. 1 and 2 and the foldable keypad 200 is disposed in the shape of a bar by being rotated and unfolded from the main body 100 in FIGS. 3 and 4. The foldable keypad 200 preferably rotates less than 180°.

The main body 100 includes a display unit 110, a first keypad 112, and a first speaker device 114 that are exposed at all times on its top 101.

The foldable keypad 200 is a double-sided keypad including keypads on its outer side 201 and inner side 202. A second keypad 212 and a second speaker device 214 are disposed on the outer side 201 and a third keypad 220 (see FIG. 3) is disposed on the inner side 202. When the foldable keypad 200 is completely folded to the main body 100, as shown in FIGS. 1 and 2, the first keypad 112 and the second keypad 212 are disposed in opposite sides with respect to the display unit 110 and the first speaker device 114 and the second speaker device 214 are disposed in opposite sides with respect to the display unit 110. When the foldable keypad 200 rotates and is completely unfolded from the main body 100 as shown in FIG. 3, the third keypad 220 and the first keypad 112 are disposed in opposite sides.

The main body 100 further includes a fourth keypad 120 that is opened and closed by the foldable keypad 200 in a lower portion of the top 101. The first keypad 112 and the second keypad 212 are used together in a state shown in FIGS. 1 and 2, and the third keypad 220 and the fourth keypad 120 are used together in a state shown in FIG. 3.

The first keypad 112 includes a 2-way key, the second keypad 212 includes a 4-way key, and the third keypad 220 includes 2×6 keys providing alphanumeric keys and character keys.

As shown in FIG. 4, a battery pack 140 and table standing protrusions 134 and 144 are included in the bottom 102 of the main body 100. The table standing protrusions 134 and 144 include a first table standing protrusion 134 protruding at a predetermined position of the bottom 102 of the main body 100 and a second table standing protrusion 144, preferably included in the battery pack 140. A camera lens 130 and an illumination device 132 are disposed between the first table standing protrusion 134 and the second table standing protrusion 144. When the main body 100 is placed on a flat surface or a table by the first table standing protrusion 134 and the second table standing protrusion 144, the camera lens 130 and the illumination device 132 are spaced apart from the table and thus protected from direct impact.

In a state shown in FIGS. 1 and 2, the user can conveniently enjoy the game mode and easily manipulate the first keypad 112 and the second keypad 212 using both hands while watching the display unit 110. In the game mode, the promptness, accuracy and efficiency of key manipulation are improved. In particular, the first speaker device 114 and the second speaker device 214 are spaced on either side of data display unit 110, whereon the user can easily view data displayed. In addition, the user can conveniently manipulate the first keypad 112 and the second keypad 212 using respective hands, and enjoy a real-like game with stereo sounds from the first speaker 114 and the second speaker 214.

In a state shown in FIG. 3, the user can easily use the portable communication terminal 10 in a general phone mode and conveniently manipulate keys on the third keypad 220 and the fourth keypad 120 while watching the display unit 110. In the phone mode, it is preferable that only the first speaker device 114 operates among the speaker devices.

As shown in FIG. 2, a first trigger key 116 adjacent to the first keypad 112 and a second trigger key 118 adjacent to the fourth keypad 120 are disposed in corner portions of one side 103 of the main body 100 for convenient use. As shown in FIG. 3, a microphone device 222 is disposed in a corner portion of an outer side end of the foldable keypad 200.

As described above, according to the present invention, a foldable keypad that is double-sided is hinged to a main body, thereby providing convenience in key manipulation in a game mode as well as a phone mode. Moreover, stereo sounds are provided in the game mode from speaker devices mounted in the foldable keypad and the main body, thereby allowing the user to enjoy a real-like game. Furthermore, it is easy to switch modes according to unfolding/folding of the foldable keypad.

While the invention has been shown and described with reference to a certain preferred embodiment thereof, it will be understood by those skilled in the art that various changes in form and details may be made therein without departing from the spirit and scope of the invention.

What is claimed is:

1. A portable communication terminal comprising:
a main body including a display unit, a first keypad, and a first speaker device that are exposed at all times on a top side of the main body;
a foldable keypad including a second keypad and a second speaker device on an outer side of the foldable keypad and a third keypad on an inner side of the foldable keypad, wherein the first keypad and the second keypad are disposed on opposite sides of the display unit, the first speaker device and the second speaker device are disposed on opposite sides of the display unit when the foldable keypad is folded to the main body, and the third keypad is exposed when the foldable keypad is unfolded from the main body; and
a hinge unit for rotatably connecting the foldable keypad to the main body.

2. The portable communication terminal of claim 1, wherein a fourth keypad exposed and hidden by respectively unfolding and folding the foldable keypad is further included on the top side of the main body.

3. The portable communication terminal of claim 1, wherein a longitudinal direction of the main body is perpendicular to a longitudinal direction of the foldable keypad.

4. The portable communication terminal of claim 1, wherein a first table standing protrusion is included in a bottom side of the main body.

5. The portable communication terminal of claim 4, wherein a battery pack is included in the bottom side of the main body and the battery pack includes a second table standing protrusion.

6. The portable communication terminal of claim 1, wherein the foldable keypad rotates less than 180° with respect to the main body.

7. The portable communication terminal of claim 5, wherein a camera lens is included between the first table standing protrusion and the second table standing protrusion and is protected from direct impact.

8. The portable communication terminal of claim 1, wherein the first keypad includes a 2-way key, the second keypad includes a 4-way key, and the third keypad includes 2×6 keys providing alphanumeric keys and character keys.

9. The portable communication terminal of claim 2, wherein a first trigger key adjacent to the first keypad and a second trigger key adjacent to the fourth keypad are disposed in corner portions of one side of the main body.
